(19) United States
(12) Patent Application Publication
(10) Pub. No.: US 2009/0179112 A1
(43) Pub. Date: Jul. 16, 2009

(54) Material for fabrication of a kite or a wing and a kite or wing incorporating the material

(76) Inventor: Xiao Wen Gu, (US)

Correspondence Address: JACKSON WALKER, L.L.P., 112 E. PECAN, SUITE 2400, SAN ANTONIO, TX, 78205, US

(21) Appl. No.: 12/008,894

(22) Filed: Jan. 14, 2008

(51) Int. Cl. B32B 5/12; B32B 9/00; B32B 7/02; B64C 31/06; B32B 15/02; B32B 27/12

(52) U.S. Cl. 244/153 R; 428/411.1; 428/339; 428/457; 442/38; 428/107

(57) ABSTRACT

A lightweight stretch resistant laminated material has a layer of thin flexible film laminated to a layer of stretch resistant reinforcing material. A kite or wing, which is known in the art to comprises a plurality of assembled panels, can have at least one such panel made from the lightweight stretch resistant laminated material.

### FIELD OF THE INVENTION

The current invention relates to kites and to flying wings, and more particularly to materials for fabrication of a kite and to kites or wings incorporating the material.

### BACKGROUND OF THE INVENTION

Kitesurfing is an extreme water, or snow, sport which utilizes a large size traction kite to pull a board rider. In most cases the kite has an inflatable frame structure to maintain its aerodynamic shape. In addition this inflatable structure provides for floatation and re-launching since water is the primary environment of kitesurfing. The sport is roughly 20 years old and evolved from “buggy racing” which is a sport that utilizes a ram air type kite to pull a 3 wheeled buggy along beaches. The re-launching of ram air kites is nearly impossible due to the fact that they collapse upon impact with the ground. The inflatable structure was developed to keep the kites in a shape close to their intended flying shape and to provide a means of easy re-launch once it had been in contact with the land or water. The kites were combined with a surfboard or snowboard and the sport of kitesurfing evolved.

Since the beginning of the sport the kites have been primarily constructed using materials easily available from the yachting industry. The inflatable structure, usually the kite's “leading edge” and “struts”, are typically made from a woven polyester material having a weight of approximately 140 to 170 gram per square meter (gsm). The kite canopy is typically made from lightweight woven Nylon or Polyester spinnaker material having a weight of approximately 50 gsm. The canopy is sewn together using typical yacht spinnaker sewing techniques utilizing either a straight stitch or zigzag stitching or a combination of both.

Although nylon and polyester canopy materials are strong and easy to manufacture they have several disadvantages. The first disadvantage is that since these materials are woven the sufferer from elongation or stretching. Elongation makes designing and maintaining the aerodynamic properties of a kite difficult and limits the performance actually obtainable from a particular aerodynamic shape than if the kite were made from more stable materials. In an attempt to avoid elongation the materials are tightly woven and are stabilized with a resin finish. This provides good control of elongation along the warp and weft directions, but bias elongation is still very excessive. Additionally, elongation properties of the material worsen with time as the finish of the material deteriorates.

Another disadvantage of nylon and polyester canopy materials is that their supply is limited to a small quantity of specialized fabric manufacturers. With rapid growth in kitesurfing in recent years fabric manufacturers have had difficulty in keeping up with demand for canopy materials. Most of the kite manufacturing takes place in China and most suppliers of the woven canopy materials are located in other parts of Asia, typically Japan, or Europe. In most cases this makes the supply and export price subject to currency fluctuations.

It is an object of the current invention to provide a material for fabrication of kites that ameliorates the above limitations and disadvantages and to provide kites or wings incorporating the material. It is also an object of the present invention to provide a material for fabrication of kites and kites or wings incorporating the material that offers kitesurfing manufactures a useful alternative to current canopy materials.

### SUMMARY OF THE INVENTION

According to a first aspect of the invention there is provided a laminated material for fabrication of a kite comprising a layer of thin flexible film laminated to a layer of stretch resistant reinforcing material.

Preferably, layers of the thin flexible film sandwich the layer of stretch resistant reinforcing material wherein the thin flexible film is Polyethylene Terephthalate.

Preferably, the thin flexible film has a thickness of the range of 0.01 mm to 0.1 mm.

Preferably, the film has a thickness of the range of 0.01 mm to 0.03 mm.

Preferably, the film has an aluminium coating.

Preferably, the stretch resistant reinforcing material is selected from a group comprising fibreglass mesh, strands of polyester yarn, loosely woven scrim or unidirectional fibres.

Preferably, the stretch resistant reinforcing material comprises stretch resistant yarn arranged in first and second groups of parallel strands with the strands in the first group crossing the strands in the second group.

Preferably, the first and second groups of parallel strands comprise 1 or more strands per inch.

Preferably, the first and second groups of parallel strands comprise 2 strands per inch.

Preferably, the inner layer further comprises a third group of parallel warp strands, and wherein the first and second groups of parallel strands are arranged at an angle to the warp strands.

Preferably, the third group of parallel warp strands comprise 1 to 8 strands per inch.

Preferably, the third group of parallel warp strands comprise 2 to 4 strands per inch.

According to a second aspect of the invention there is provided a kite or wing made from a plurality of assembled panels wherein at least one panel comprises the laminated material having a layer of thin, flexible film laminated to a layer of stretch resistant reinforcing material as described herein.

Preferably, the panel of laminated material is joined to other panels of the laminated material or of a different material at seams reinforced with a tape layer.

Preferably, leading and trailing edges and tips of the kite or wing are reinforced with a woven nylon or polyester fabric attached to the laminated material.

According to a further aspect of the invention there is provided a kite or wing comprising a leading edge strut and a plurality of rib struts supporting a flexible envelope wherein at least a portion of the flexible envelope comprises the laminated material defined above.

Preferably, the flexible envelope comprises a plurality of panels located between the rib struts and extending from the leading edge strut towards a trailing edge of the kite and wherein at least one of the panels comprises the laminated material.

Preferably, portions or panels of the kite or wing bearing a load or stress are reinforced with a woven nylon or polyester fabric attached to the laminated material.

### BRIEF DESCRIPTION OF THE DRAWINGS

Further disclosure and aspects of the invention are provided in and will become apparent from the following description which is given by way of example only and with reference to the accompanying drawings, in which:

FIGS. 1 and 2 illustrate top views of a laminated material for fabrication of a kite or wing,

FIG. 3 illustrates a cross section view of the laminated material,

FIG. 4 illustrates a perspective view of a kite incorporating the material of FIGS. 1-3,

FIG. 5 illustrates a flatted top view of the kite, and

FIGS. 6 through 8 illustrate different joining techniques for the laminated material.

### DETAILED DESCRIPTION OF THE PREFERRED EMBODIMENTS

Referring to FIGS. 1 through 3, the laminated material comprises two outer layers 1, 2 of thin, non woven, flexible film sandwiching an inner layer 3 of stretch resistant reinforcing material. In the preferred embodiment the non woven flexible film is 0.02 millimetres thick aluminium coated Polyethylene Terephthalate (PET) film, and the reinforcing material comprises stretch resistant polyester yarn arranged in first and second groups of parallel strands 4, 5 with the strands in the first group crossing the strands in the second group at an angle of between 30 and 60 degrees. The layers 1, 2, 3 are laminated together in a typical laminating process using BOSTIK® solvent base polyester resin glue. The material is easily manufactured, low cost and has high strength and low elongation in all directions.

Although PET film is preferred because it is cheap, easily obtainable or manufactured, and has high tensile strength and dimensional stability for it relative thickness, the outer layers of flexible film 1, 2 may be any suitable non woven film material. Typical examples include, but are not limited to, non woven polyester film, metallic film, color pattern screening films, or any combination of Polyester, Thermoplastic Polyurethane (TPU), Polyurethane, Polyethylene, Tedlar, or Polypropylene film. Typically, the thin flexible film will be in the range of 0.01 to 0.1 millimetres thick depending on the desired strength, stability and weight characteristic of the kite design. For lightweight performance kites the film will typically be between 0.01 and 0.03 millimetres thick.

In the preferred embodiment the reinforcing material comprises stretch resistant polyester yarn arranged in first and second groups crossing at an angle of between 30 and 60 degrees. In other embodiments the reinforcing layer may comprise any other low weight high strength yarns. Typical examples include, but are not limited to, Ultra high molecular weight polyethylene (UHMWPE) yarn, Polyaramide yarn, fibreglass mesh, strands of polyester yarn, woven scrim, unidirectional fibres or an “X” pattern or very loosely woven yarns made usually from polyester, nylon, carbon or Arimid fibres.

The groups 4, 5 of strands may cross at an angle of anywhere from 10 to 80 degrees. The first and second groups of parallel strands 4, 5 comprise 2 strands per inch, but this is not critical to the invention and may be more or less strands per inch. In some embodiments there is also a third group of parallel warp or weft strands 6 comprising 2 strands per inch in the first pattern 7 and 4 strands per inch in the second pattern 8. Again, this is not critical to the invention and may be more or less strands per inch. There should not be so many strands per inch as to affect bonding of the upper and lower layers 1, 2. The layers 1, 2, 3 can be laminated together using a suitable glue, which should be readily determinable by those skilled in the art. Typical examples of suitable glue include BOSTIK® solvent base polyester resin glue or water based 1001 glue from National Starch.

In the preferred embodiment the new material comprises three laminated layers. In some applications, for example low stress or lightweight applications, the material may comprises only a single layer of film laminated to a stretch resistant reinforcing material.

The new material has the following advantages over current nylon and polyester canopy materials:
Low elongation in all directions, which improves the performance of the kite offering profile stability and increased turning response to input from the rider.
Substantial cost savings in comparison to woven materials.
Availability of new assembly construction methods such as seam gluing or welding eliminating the weaknesses of traditional kite construction methods.
The smooth surface offers good adhesion for tapes or reinforcement adhesive materials eliminating the need for sewing seams in some areas or the kite.
Possibility of manufacture in China near or in kite manufacturing factories.
The new laminated fabric does not absorbed water during water landings or crashes.

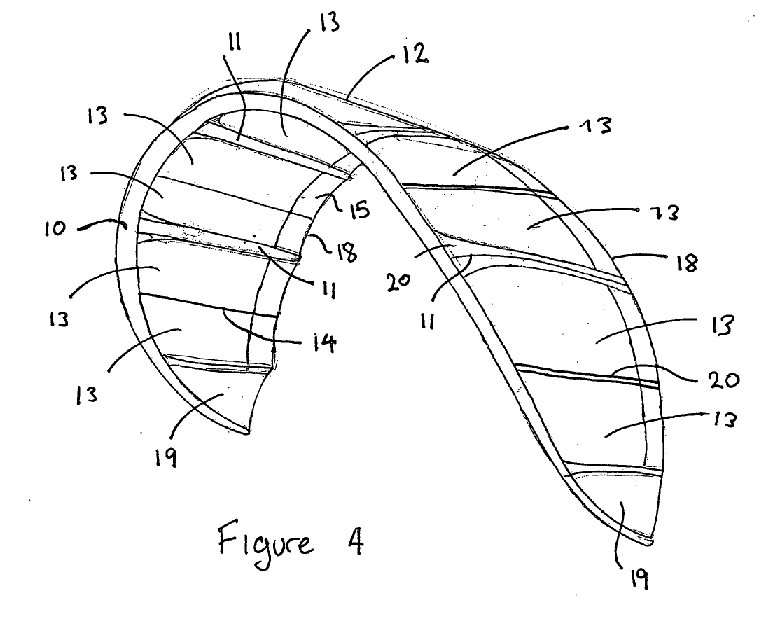

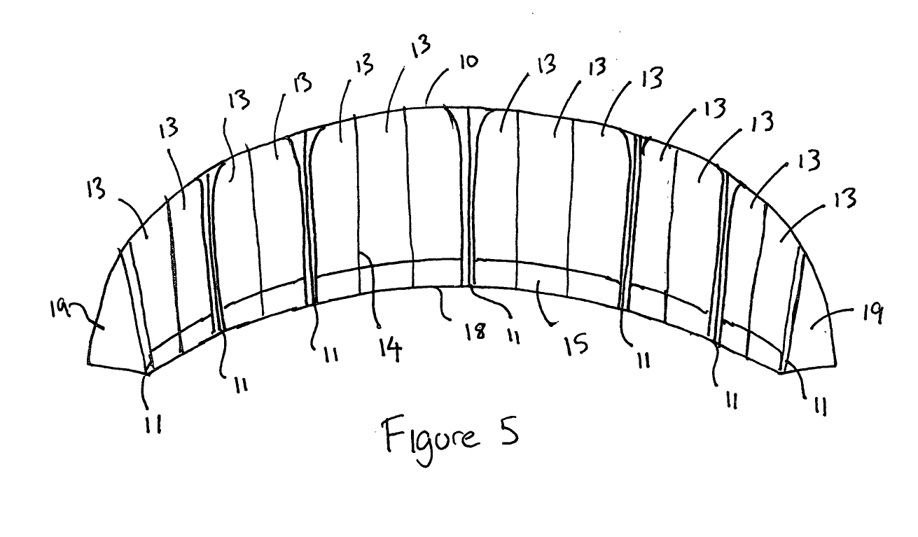

Referring to FIGS. 4 and 5, an example of a kite or wing incorporating the material has a leading edge strut 10 and a plurality of rib struts 11 supporting a flexible envelope 12. The flexible envelope 12 extends spanwise between two wing tips 19 and chordwise between the leading edge strut and a trailing edge 18. The leading edge strut 10 and plurality of rib struts 11 are made from woven polyester material as is known in the art. The flexible envelope 12 comprises a plurality of panels 13 located between the rib struts 11 and extending from the leading edge strut 10 towards the trailing edge 18. In the preferred embodiment of a kite of the invention all of the flexible envelope panels 13 are made of the new laminated material. Where the panels of laminated material join to other panels of the laminated material or of a different material the seams 14 are reinforced with tape 20 and stitched as described later with reference to FIG. 6. The trailing edge 18 is provided with a strip 15 of reinforcing material to prevent rips or tears under load.

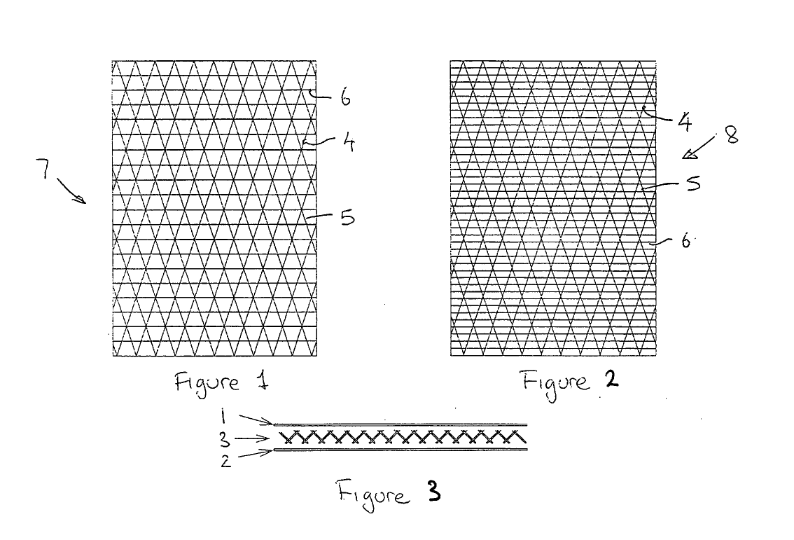

In other embodiments of the kite only one of the panels 13 might be the new laminated material described above, or the whole kite may be made of the laminated material. In embodiments where a portion or the entire kite are made of the new laminated material any part or panel of the kite bearing a load or under stress (such as the struts, leading and trailing edges, wing tips and seams) is preferably reinforced with a woven nylon or polyester fabric attached to the laminated material 12. For example, in the embodiment depicted in FIGS. 2 and 3 the panels 13 can be framed in woven nylon or polyester fabric to strengthen edges of the panels bearing additional load and stress.

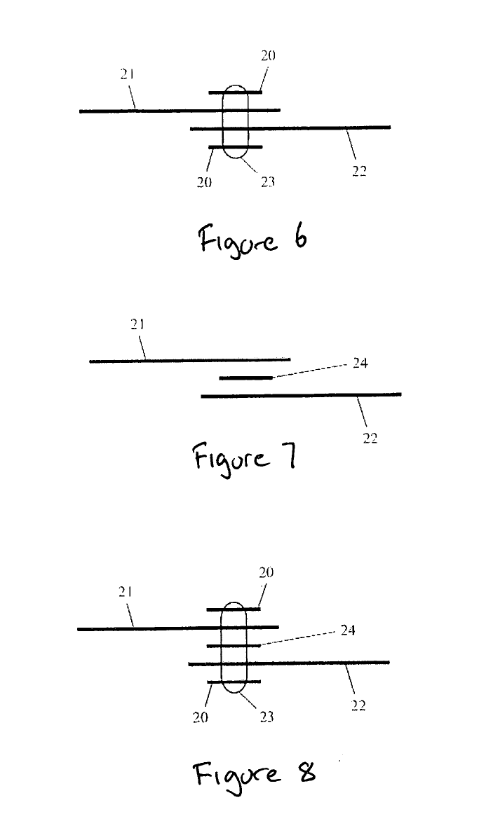

The new material may be joined along seams 14 using a variety of techniques, for example stitching, gluing, adhesive tape or welding. A seam glued, taped or welded can additionally be reinforced with stitching. FIGS. 6 through 8 illustrate various joining techniques. In FIG. 6 two panels 21, 22 are joined by stitching 23 with reinforcing tape 20 in the top and bottom of the seam. In FIG. 7 the two panels 21, 22 are joined with a layer 24 of glue or adhesive tape. In FIG. 8 the two panels 21, 22 are joined with a layer 24 of glue or adhesive tape, and further reinforced by stitching 23 with reinforcing tape 20 in the top and bottom of the seam.

It should be appreciated that modifications and/or alterations obvious to those skilled in the art are not considered to be beyond the scope of the present invention.

1. A laminated material for fabrication of a kite comprising a layer of thin flexible film laminated to a layer of stretch resistant reinforcing material.

2. The laminated material of claim 1 comprising outer layers of the thin flexible film sandwiching an inner layer of stretch resistant reinforcing material wherein the thin flexible film is Polyethylene Terephthalate.

3. The laminated material of claim 1 wherein the thin flexible film has a thickness of the range of 0.01 mm to 0.1 mm.

4. The laminated material of claim 3 wherein the film has a thickness of the range of 0.01 mm to 0.03 mm.

5. The laminated material of claim 1 wherein the film has an aluminium coating.

6. The laminated material of claim 2 wherein stretch resistant reinforcing material is selected from a group comprising fibreglass mesh, strands of polyester yarn, loosely woven scrim or unidirectional fibres.

7. The laminated material of claim 1 wherein the stretch resistant reinforcing material comprises stretch resistant yarn arranged in first and second groups of parallel strands with the strands in the first group crossing the strands in the second group.

8. The laminated material of claim 7 wherein first and second groups of parallel strands comprises 1 or more strands per inch.

9. The laminated material of claim 8 wherein the first and second groups of parallel strands comprises 2 strands per inch.

10. The laminated material of claim 6 wherein the inner layer further comprises a third group of parallel warp strands, and wherein the first and second groups of parallel strands are arranged at an angle to the warp strands.

11. The laminated material of claim 10 wherein the third group of parallel warp strands comprise 1 to 8 strands per inch.

12. The laminated material of claim 11 wherein the third group of parallel warp strands comprise 2 to 4 strands per inch.

13. A kite or wing made from a plurality of assembled panels wherein at least one panel comprises the laminated material of claim 1.

14. The kite or wing of claim 13 wherein the panel of laminated material is joined to other panels of the laminated material or of a different material at seams reinforced with a tape layer.

15. The kite or wing of claim 14 wherein leading and trailing edges and tips of the kite or wing are reinforced with a woven nylon or polyester fabric attached to the laminated material.

16. A kite or wing comprising a leading edge strut and a plurality of rib struts supporting a flexible envelope wherein at least a portion of the flexible envelope comprises the laminated material of claim 1.

17. The kite or wing of claim 16 wherein the flexible envelope comprises a plurality of panels located between the rib struts and extending from the leading edge strut towards a trailing edge of the kite and wherein at least one of the panels comprises the laminated material.

18. The kite or wing of any one of claim 13 wherein portions or panels of the kite or wing bearing a load or stress are reinforced with a woven nylon or polyester fabric attached to the laminated material.
